(19) United States
(12) Patent Application Publication
(10) Pub. No.: US 2020/0027104 A1
(43) Pub. Date: Jan. 23, 2020

(54) SYSTEM AND METHOD FOR PROCESSING DIGITAL TRAFFIC METRICS

(71) Applicant: VIZDYNAMICS PTY LTD, Melbourne (AU)

(72) Inventors: Andrew PRENDERGAST, South Yarra (AU); Paul CROSS, Brighton (AU); Dhruv BHATIA, Armadale (AU); Mark GORMLEY, South Yarra (AU); Ryan SANTOS, Caroline Springs (AU)

(21) Appl. No.: 16/526,793

(22) Filed: Jul. 30, 2019

Related U.S. Application Data
(62) Division of application No. 14/430,870, filed on Mar. 24, 2015, now abandoned.

(30) Foreign Application Priority Data
Sep. 25, 2012 (AU) 2012904190

(51) Int. Cl. G06Q 30/02; H04L 12/26

(52) U.S. Cl. CPC G06Q 30/0204; H04L 43/062; G06Q 30/0246; G06Q 30/0241

(57) ABSTRACT

A computer-implemented method is disclosed for processing metrics via a controller. The controller comprises a processor and a memory storing program instructions which when executed by the processor causes implementation of the steps of generating or receiving metrics characterising digital traffic and/or related user behaviour from one or more sources and generating or receiving a tabular dataset associated with the metrics, wherein the dataset comprises rows of metrics and dimensions in which each row represents a subset of a metric grouping characterised by a combination of dimensions. The processor further implements the steps of receiving one or more partition identifiers representing a data structure of dataset partitions, assigning one or more metric groupings to one or more partition identifiers and analysing the dataset according to partition identifiers.

### CROSS-REFERENCE TO RELATED APPLICATIONS

The application is a divisional of U.S. patent application Ser. No. 14/430,870, filed Mar. 24, 2015, titled “SYSTEM AND METHOD FOR PROCESSING DIGITAL TRAFFIC METRICS,” which is a 371 of International Application No. PCT/AU2013/001094, filed Sep. 25, 2013, titled “SYSTEM AND METHOD FOR PROCESSING DIGITAL TRAFFIC METRICS,” and claims priority to Australian Patent Application No. 2012904190, filed Sep. 25, 2012, titled “SYSTEM AND METHOD FOR PROCESSING DIGITAL TRAFFIC METRICS,” all of which are incorporated herein by reference in their entireties.

### FIELD OF THE INVENTION

The present invention relates generally to a method and system for processing metrics relating to digital traffic occurring between interconnected entities forming part of a computer network. The invention has particular application in the field of processing digital traffic metrics relating to digital advertising activity on the internet, and it will be convenient to describe the invention in relation to that exemplary application.

It will be appreciated however, that the invention is not limited to that application only. For example, the invention can be applied to any data maintained in a data warehouse, or any dataset relating to digital traffic in the field of paid media (such as advertising), owned media (such as email, website analytics), earned digital traffic (such as traffic resulting from social media applications including Twitter and Facebook) and mobile and tablet digital traffic.

### BACKGROUND

Existing advertising serving systems contain a plethora of information about advertising traffic flows and related user behaviour. These datasets, whilst very detailed, are not organised in such a way that is useful to a business since the structure of the data is very operational and generally tailored to individual campaigns. Moreover, such datasets lack critical information useful to a business, such as budget, targets and forecasts. These datasets also represent different views of the same marketing activity and thus building a view of activity across multiple platforms requires manual joining and de-duplication of data.

It would therefore be desirable to provide a method and system for processing digital traffic metrics which allows users to reorganise and/or augment datasets relating to digital traffic in a convenient and useful manner and to provide more meaningful reporting of such datasets to that user. It would also be desirable to provide a method and system for processing digital traffic metrics which ameliorates or overcomes one or more disadvantages or inconveniences of known digital traffic metric processing systems and methods.

### SUMMARY OF THE INVENTION

According to a first aspect of the present invention, there is provided a computer implemented method of processing metrics via a controller, the controller comprising a processor and a memory storing program instructions which when executed by the processor causes implementation of the steps of:

generating or receiving metrics characterising digital traffic and/or related user behaviour from one or more sources;

generating or receiving a tabular dataset associated with the metrics, the dataset comprising rows of metrics and dimensions in which each row represents a subset of a metric grouping characterised by a combination of dimensions;

receiving one or more partition identifiers representing a data structure of dataset partitions;

assigning one or more metric groupings to one or more partition identifiers; and

analysing the dataset according to the partition identifiers.

The digital traffic may include advertising traffic flows, or digital traffic flow resulting from email, website analytics, and social media. The digital traffic may flow between any one of a number of networked devices, including fixed computing terminals, mobile computing terminals and tablets.

The dimensions associated with the dataset may include date, campaign descriptor and keyword/s.

In one or more embodiments, the code when executed by the processor may further cause implementation of the step of writing the partition identifiers to the dataset. In one or more embodiments, the partition identifiers associate rows of data in the dataset with nodes in a predetermined data structure, such as a linear list, hierarchical tree or multiply connected graph structure, thus causing the metric groupings and their associated dimensions and metrics to be navigable and aggregable according to the dataset partitions.

In one or more embodiments, one or more metric groupings may be assigned to multiple partitions. In other embodiments however, one or more metric groupings may be assigned to a single partition.

According to a second aspect of the invention, there is provided a computer implemented method of processing metrics via a controller, the controller comprising a processor and a memory storing program instructions which when executed by the processor cause implementation of the steps of:

generating or receiving metrics characterising digital traffic and/or related user behaviour from one or more sources;

generating or receiving a tabular dataset associated with the metrics, the dataset comprising rows of metrics and dimensions in which each row represents a subset of a metric grouping characterised by a combination of dimensions;

receiving supplementary metrics and/or dimension data; and

writing the supplementary metrics and/or dimension data and to the dataset.

In one or more embodiments, the aforementioned series of steps may be executed separately from or in addition to the series of steps in which partition identifiers are assigned to one or more metric groupings.

According to another aspect of the present invention, there is provided a computer implemented method of processing metrics via a controller, the controller comprising a processor and a memory storing code which when executed by the processor causes implementation of the steps of:

generating or receiving metrics characterising digital traffic and/or related user behaviour from first and second sources;

generating or receiving a first dataset X of metrics derived from the first source and a second dataset Y of metrics derived from the second source, the datasets comprising rows of metrics and dimensions in which each row represents a subset of a metric grouping characterised by a combination of dimensions; and

merging the multiple datasets into a single dataset by application of a mapping function to the first and second datasets X and Y the mapping function acting to determine which levels of a dimension in the first dataset are mapped onto which levels of another dimension in the second dataset.

In one or more embodiments of the invention, the code when executed by the processor further causes implementation of the step of learning the mapping function B from the first and second datasets.

In one or more embodiments, the mapping function B≅A⁻¹C,

A being a matrix constructed from the second dataset Y and consisting of |T| rows and |Y| columns, each row in A containing the value of a metric M that occurs in both the first and the second datasets for a predetermined period, and each column in A contains the value of M for one level in the dimension Y; and

C being a matrix constructed from the first dataset X consisting of |T| rows and |X| columns, each row in C containing the value of M for the predetermined period, and each column in C contains the value of M for one level in the dimension X.

In one or more embodiments, the predetermined period may be a day or other time period.

In one or more embodiments, when B is a positive integer matrix, and the sum of all cells in the matrix B is equal to MAX(|X|,|Y|), a linear or non-linear solver is run by the processor to learn the mapping function B.

In one or more embodiments, a least squares matrix solver is run by the processor to learn the mapping function B.

According to another aspect of the invention, there is provided a controller for processing metrics, the controller comprising a processor and a memory storing program instructions which when executed by the processor causes implementation of the steps of:

generating or receiving metrics characterising digital traffic and/or related user behaviour from one or more sources;

generating or receiving a tabular dataset associated with the metrics, the dataset comprising rows of metrics and dimensions in which each row represents a subset of a metric grouping characterised by a combination of dimensions;

receiving one or more partition identifiers representing a data structure of dataset partitions;

assigning one or more metric groupings to one or more partition identifiers; and

analysing the dataset according to partition identifiers.

According to a further aspect of the invention, there is provided a controller for processing metrics, the controller comprising a processor and a memory storing program instructions which when executed by the processor causes implementation of the steps of:

generating or receiving metrics characterising digital traffic and/or related user behaviour from one or more sources;

generating or receiving a tabular dataset associated with the metrics, the dataset comprising rows of metrics and dimensions in which each row represents a subset of a metric grouping characterised by a combination of dimensions;
receiving supplementary or additional metrics and/or dimension data; and

writing the supplementary or additional metrics and/or dimension data to the dataset.

According to a still further aspect of the invention, there is provided a controller for processing metrics, the controller comprising a processor and a memory storing code which when executed by the processor causes implementation of the steps of:

generating or receiving metrics characterising digital traffic and/or related user behaviour from first and second sources;

generating or receiving a first dataset X of the metrics derived from the first source and a second dataset Y of the metrics derived from the second source, the datasets comprising rows of metrics and dimensions in which each row represents a subset of a metric grouping characterised by a combination of dimensions; and

merging the multiple datasets into a single dataset by application of a mapping function to the first and second datasets X and Y, the mapping function acting to determine which levels of a dimension in the first dataset X are mapped onto which levels of another dimension in the second dataset Y.

According to a further aspect of the invention, there is provided a user interface for use with a controller as described hereabove, the user interface having a windowing capability enabling a user to:

specify one or more partition identifiers representing a data structure of dataset partitions; and

assign one or more metric groupings to one or more partition identifiers.

According to a still further aspect of the invention, there is provided a user interface for use with a controller as described hereabove, the user interface having a windowing capability enabling a user to:

enter supplementary metrics and/or dimension data; and

assign one or more partition identifiers to the supplementary metrics and/or dimension data.

The user interface may further include a windowing capability enabling a user to add additional data rows of metrics and dimensions to the dataset.

The user interface may further include a windowing capability enabling a user to split data rows of metrics and dimensions in the dataset.

The user interface may further include a windowing capability enabling a user to select metrics and/or dimensions from the first and second datasets which are to be joined by positioning opposing ends of at least one connector onto graphic elements representing metrics and/or dimensions to be joined.

According to yet another aspect of the invention, there is provided a user interface for use with a controller as described hereabove, the user interface having a windowing capability enabling a user to:

select metrics and/or dimensions from the first and second datasets which are to be joined.

According to a still further aspect of the present invention, there is provided a non-transitory computer readable medium storing program instructions which when executed by a processor causes implementation of the method as described hereabove.

### BRIEF DESCRIPTION OF THE DRAWINGS

The invention will now be described in further detail by reference to the accompanying drawings. It is to be understood that the particularity of the drawings does not supersede the generality of the preceding description of the invention.

FIG. 1 is a schematic diagram of a system for processing metrics in accordance with one embodiment of the present invention;

FIG. 2 is a schematic diagram of a controller forming part of the system for processing metrics depicted in FIG. 1;

FIGS. 3 and 5 are an exemplary tabular datasets of the type which may be stored on any one of the advertising platform databases forming part of the system for processing metrics depicted in FIG. 1;

FIG. 4 is a chart depicting a hierarchical tree data structure into which the datasets depicted in FIG. 3 is segmented;

FIGS. 6a through 8f show graphic user interface windows for use with the system for processing metrics depicted in FIG. 1;

FIG. 9 is a schematic diagram showing various operations able to be performed by a user of the system for processing metrics depicted in FIG. 1 via the graphics user interface of that system;

FIG. 10 shows a database structure used for the stored dimensions, metrics, as well as the stored partition identifiers and associated augmented metrics in a server forming part of the system for processing metrics depicted in FIG. 1;

FIGS. 11a and 11b are a schematic diagram depicting the merging of two datasets carried out by a server forming part of the system for processing metrics depicted in FIG. 1; and

FIG. 12 shows a further graphic user interface windows for use with the system for processing metrics depicted in FIG. 1.

### DETAILED DESCRIPTION

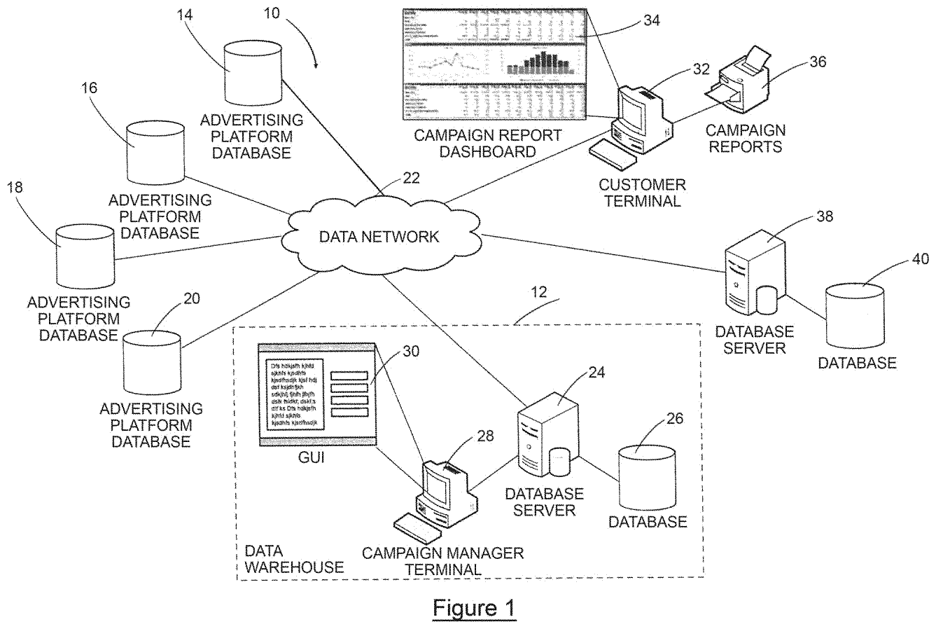

Referring firstly to FIGS. 1 and 9, there is shown an exemplary system 10 for processing digital advertising metrics.

The system 10 includes a data warehouse 12 connected to a series of advertising platform data bases 14 to 20 via a data network 22, such as the Internet. A series of the advertising platform databases 14 to 20 store datasets of information relating to digital traffic and related user behaviour. The datasets stored on each of the databases 14 to 20 relates to separate traffic measurement platforms that have been run by the proprietors of each of the databases 14 to 20. These datasets are provided to the data warehouse 12, and specifically to a database server 24 in communication with the network 22 and stored in a database 26 associated with the database server 24.

A terminal 28 and associated graphic user interface 30 enable a campaign manager or other user to interact with the datasets stored in the database 26. Once the datasets have been reorganised, augmented and/or merged at the data warehouse 12, the resultant datasets are transmitted to a customer terminal 32 to enable viewing of a consolidated campaign reporting board 34 on the display of the customer terminal 32, or alternatively to generate printed campaign reports from a printer 36 in communication with customer terminal 32. In addition, the consolidated datasets may be transmitted from the database server 24 to a customer database server 38 and associated database 40 in communication with the data network 22.

The data warehouse 12 enables the reorganising of the datasets from the various advertising platform databases 14 to 20 into a predetermined data structure by partitioning the various datasets, improving the datasets with additional business specific metric data and furthermore provides a way to combine multiple views of activity into a single de-duplicated dataset. The graphic user interface 30 provides the campaign manager with the functionality required to specify an indefinitely deep tree hierarchy 200, or other predetermined structure, and a point-and-click facility for assigning advertising activity data from multiple advertising systems to any node (partition) in this user defined hierarchy 190. The graphic user interface 30 furthermore provides a means of entering new or overwriting existing metric data at any node in the hierarchy 170. Furthermore, when data from two or more advertising systems are assigned to a node in the hierarchy, a machine learning algorithm detects which dimensions in a first system are to be mapped to which dimensions into dimensions in the other system.

It should be appreciated that the computer implemented method of processing metrics described herein could be applied not only to advertising datasets, but to any dataset in general. Any company or organisation with a data warehouse that has a need to reorganise their datasets, add additional data to their datasets and/or merge multiple datasets together will benefit from the advantages provided by the present invention.

The system 10 may be implemented using hardware, software or a combination thereof and may be implemented in one or more computer systems, controllers or processing systems. In particular, the functionality of the client user terminal 32 and its graphic user interface 34, as well as the server 24 may be provided by one or more computer systems capable of carrying out the above described functionality.

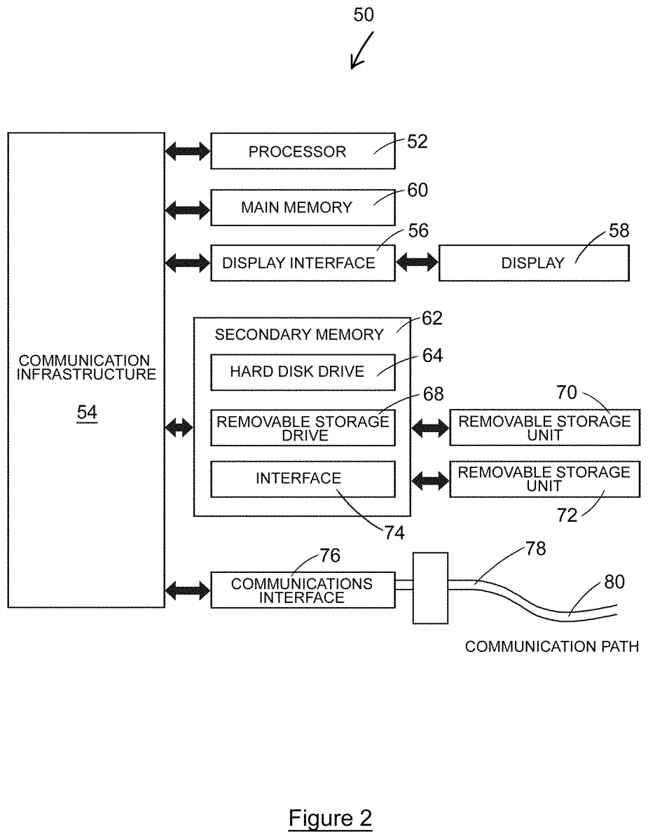

An exemplary controller 50 is shown in FIG. 2. The controller 50 includes one or more processors, such as processor 52. The processor 52 is connected to a communication infrastructure 54. The controller 50 may include a display interface 56 that forwards graphics, texts and other data from the communication infrastructure 54 for supply to the display unit 58. The controller 50 may also include a main memory 60, preferably random access memory, and may also include a secondary memory 62.

The secondary memory 62 may include, for example, a hard disk drive 64, magnetic tape drive, optical disk drive, etc. A removable storage drive 68 reads from and/or writes to a removable storage unit 70 in a well-known manner. The removable storage unit 70 represents a floppy disk, magnetic tape, optical disk, etc.

As will be appreciated, the removable storage unit 70 includes a computer usable non-transitory storage medium having stored therein computer software in a form of program instructions to cause the processor 52 to carry out desired functionality. In alternative embodiments, the secondary memory 62 may include other similar means for allowing computer programs or program instructions to be loaded into the controller 50. Such means may include, for example, a removable storage unit 72 and interface 74.

The controller 50 may also include a communications interface 76. Communications interface 76 allows software and data to be transferred between the controller 50 and external devices. Examples of communication interface 76 may include a modem, a network interface, a communications port, a PCMIA slot and card etc. Software and data transferred via a communications interface 76 are in the form of signals 78 which may be electromagnetic, electronic, optical or other signals capable of being received by the communications interface 76. The signals are provided to communications interface 76 via a communications path 80 such as a wire or cable, fibre optics, phone line, cellular phone link, radio frequency or other communications channels.

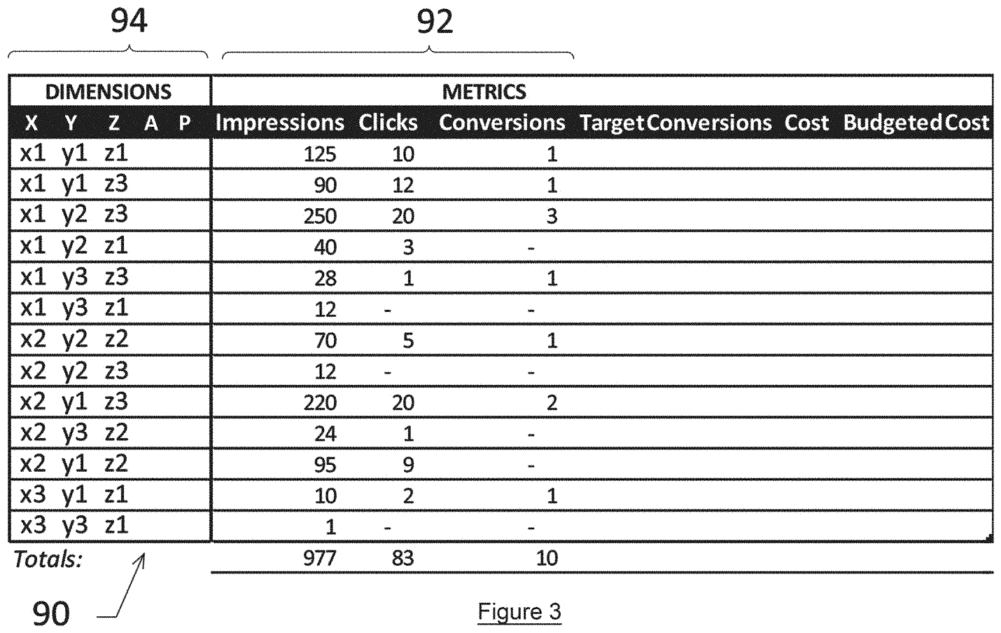

Referring now to FIGS. 3 and 9, there is shown an exemplary tabular dataset 90 of the type which may be stored on any one of the advertising platform databases 14 to 20. The dataset 90 includes a series of metrics 92 characterising digital traffic and related user behaviour resulting from an advertising campaign together with a series of dimensions 94 defining various characteristics or parameters of the advertising campaign. In this case, the recorded metrics include impressions, clicks and conversions. The dimensions X, Y and Z may correspond to the data of the activity, the particular campaign and a predetermined key word used in content displayed to a user, where x1, x2 and x3 represent different dates, y1, y2 and y3 represent different advertising campaigns, and z1, z2 and z3 represent different keywords.

The tabular dataset 90 consists of rows of metrics and dimensions in which each row represents a subset of a metric grouping characterised by a combination of dimensions. Accordingly, each row in the dataset comprises a metric grouping running a different combination of dimensions (such as date, campaign, keyword) and records the impressions, clicks and conversions occurring when that specific combination of dimensions occurred. Other datasets having different dimensions and recording different metrics against various combinations of dimensions may be recorded in the other advertising platform databases.

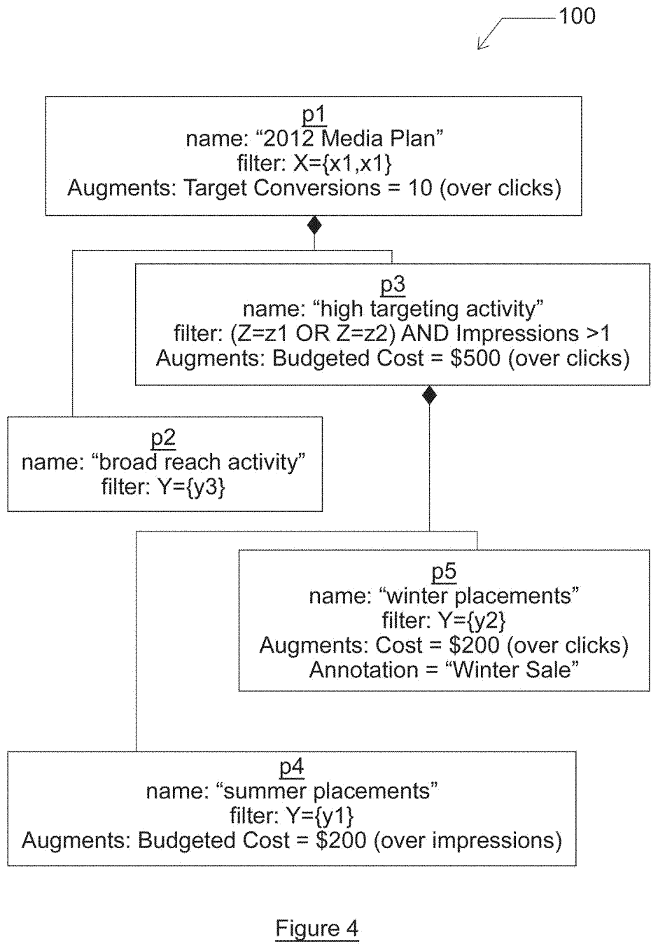

By use of the graphic user interface 30, a campaign manager 160 is firstly able to specify a hierarchy or other data structure of partitions 200 into which the dataset can be divided for subsequent analysis. Partition identifiers are used to associate rows of data in the dataset with nodes in a data structure, such as a linear list, hierarchical tree or multiply connected graph structure, one such exemplary hierarchical tree data structure 100 is depicted in FIG. 4. In this hierarchy, an upper level is identified by a partition identifier p1 and covers all metrics for which the first dimension X has a value of x1 or x2 (which may, for example, correspond to all metrics recorded during two days.

Beneath the upper level partition p1 exists two data partitions identified by partition identifiers p2 and p3. Partitions may be defined by way of logic such as Boolean logic, set logic or the like. For example, the partition p2 includes all metrics falling within the data partition p1 and having a value of the Y dimension as y3 (and for example, defined by set logic as Y={y3]). The data partition p3 includes all metrics falling within the data partition p1 where the value of the said dimension is either z1 or z2 and Impressions greater than 1 (and for example, defined by Boolean logic as (Z=z1 OR Z=z2) AND Impressions >1). Finally, the data structure 100 includes two further low level dataset partitions respectively having partition identifiers p4 and p5. The data partition p4 includes metrics falling within the data partition p3 and having a Y dimension with a value of y1, whilst the data partition p5 may include all metrics falling within the data partition p3 and having a Y dimension value of y2. The partition identifiers p1 to p5 are assigned to one or more of the metric groupings (rows) depicted in the dataset 90.

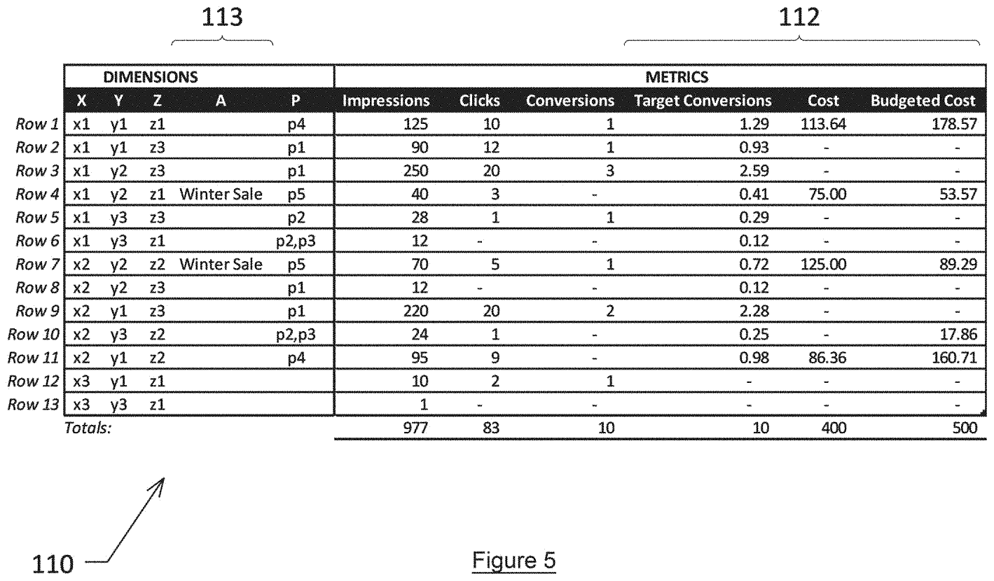

FIG. 5 depicts a dataset 110 corresponding to the dataset 90 but now includes a further dimension P in which the partition identifiers depicted in FIG. 4 have been added to relevant metric groupings. The provision of one or more additional dimensions to the dataset 90 enables the dataset to be segmented and analysed according to the data partitions p1 to p5 shown in FIG. 4 to thereby provide improved or useful data reporting to an advertising campaign customer.

In addition to the supplementary dimension data provided by the partition identifiers, the dataset 110 depicts supplementary metrics 112 which have been added to the metrics 92 as well as supplementary dimensions 113 which have been added to the dimensions 94 described in relation to the dataset 90 according to the data structure depicted in 100. In this example, the supplementary metrics define target conversions, costs and budgeted costs while the supplementary dimensions define annotations.

In the example data structure 100, p1 contains the supplemental metric Target Conversions which should be set to 10 with the allocation weighted according to the Clicks metric. Referring to 112, you can see the results of this, with the Target Conversions column now summing to 10, and a weighted average applied according to the Click metric.

As another example, in the data structure 100 p4 and p5 contain supplemental metrics for Budgeted Cost which each should be set to $200. Referring again to 112, the Budgeted Cost column now sums to $400, with $200 distributed across rows 1 and 11 according to a weighted average on Impressions (p4) and an additional $200 distributed across rows 4 and 7 according to a weighted average on Clicks (p5).

As well as receiving supplementary metrics and/or dimension data and writing that supplementary metrics and/or dimension data and partition identifiers to a particular dataset, the data warehouse 12 is also adapted to enable updated metrics and/or dimension data to be received and written to a dataset.

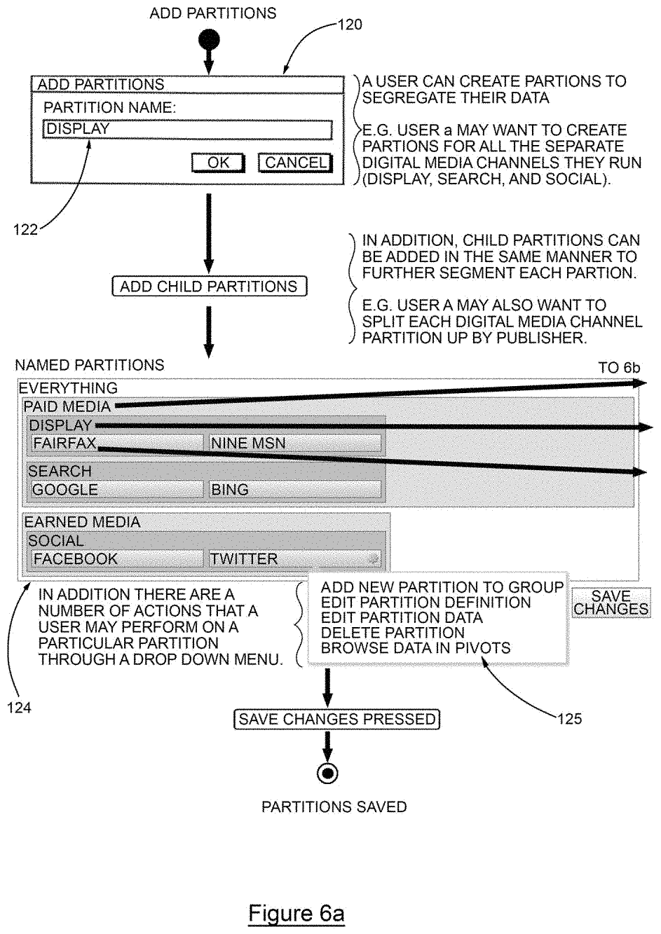

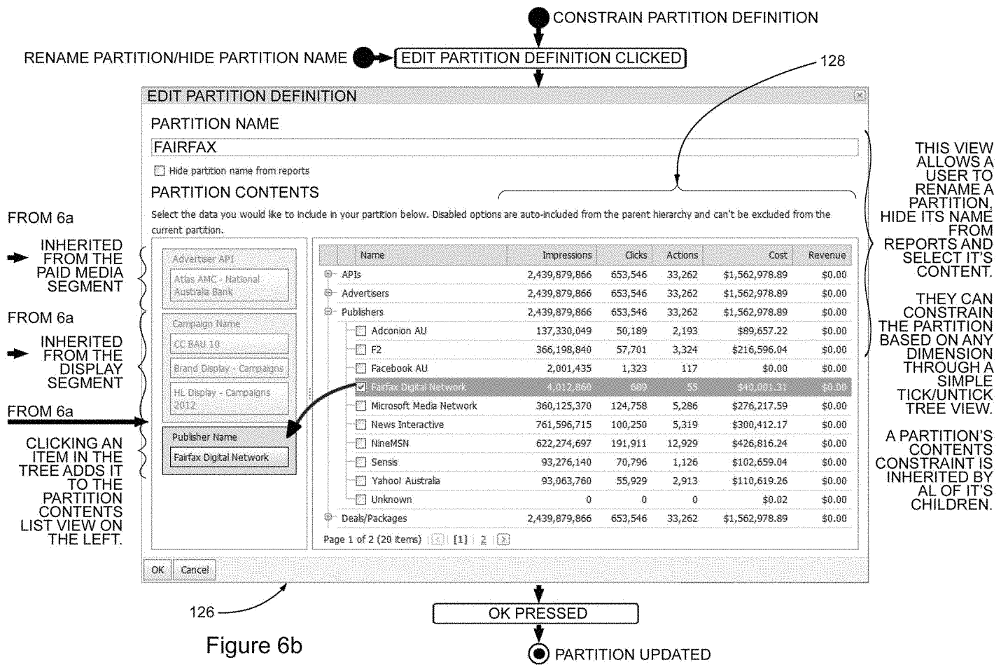

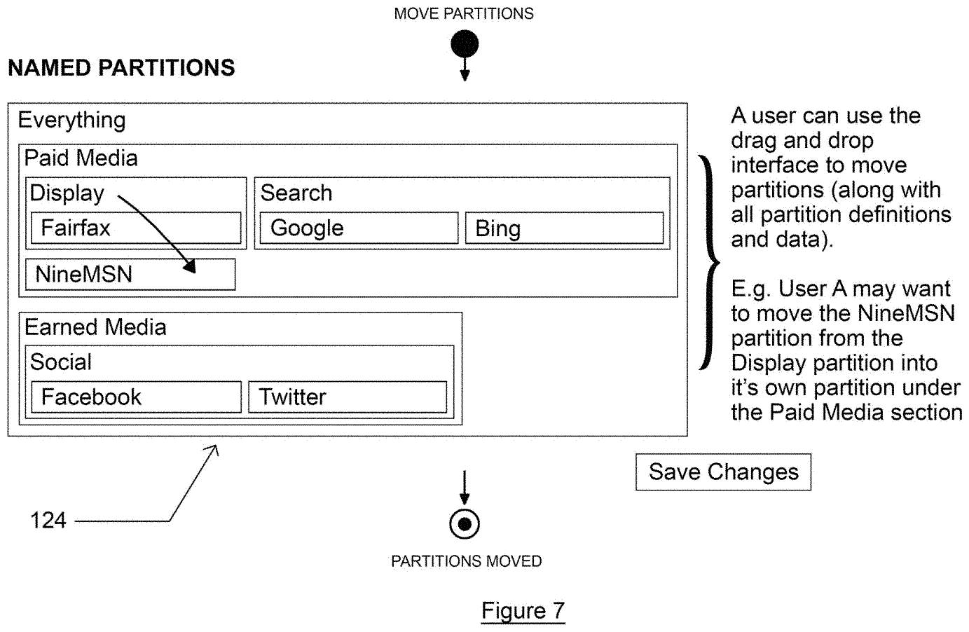

Operation of the graphic user interface 30 so as to allow a user to define a hierarchy or other data structure of dataset partitions will now be explained with reference to FIGS. 6 to 9.

As can be seen in FIGS. 6 and 9, when a user 160 intends to add dataset partitions to a particular dataset, the user selects an interface portion 120 of the graphic user interface 30 to create a partition 202 to be used to segregate the data in the dataset. For example, a user may wish to create partitions for all separate digital media channels they run, such as display, search and social categories. Once the partition name is entered into the interface window 122, the user is then able to add child partitions 202, that is, partitions arranged at a lower hierarchical level than the partition just entered. This way child partitions can be used to further segment each partition. For example, a user may wish to split each digital media channel partition by publisher.

The graphic user interface 30 provides various interface portions depicting each created partition. The position of each partition within the hierarchical data structure can be altered by a user friendly drag and drop functionality 204 and 206, whereby a user is able to either delete a partition or select an interface portion corresponding to a particular data partition in order to reposition that interface window to a higher or lower hierarchical position with respect to the other data partitions displayed. Once the graphical representation 124 of the interface portions corresponding to each partition graphically presented in a desired hierarchical structure are settled, the changes can then be recorded by the campaign manager in the data base server 24.

A further interface window 126 is provided so that a user may select an interface portion corresponding to a particular data partition 190 and thereafter have displayed in the interface window 126 the various metrics associated with that particular data partition 192. In the example shown in FIG. 6, a “Fairfax” publisher data partition has been defined as a child partition within a “display” digital media channel data partition, which is itself a child data partition within a “paid media” data partition. Selection of the “Fairfax” interface portion causes display of the interface window 126 as well as the various metrics 128 recorded by each of the various data partitions at that hierarchical level.

Functionality is also provided by the graphic user interface 30 to enable editing of that particular data partition 192. For example, rather than selecting data from the “Fairfax” publisher, a data partition corresponding to a different publisher may be selected on the interface window 126.

Moreover, as shown in FIG. 7, the position of a data partition within a hierarchical structure can be altered from the interface window 124. In the example shown in FIG. 7, the “NineMSN” publisher data partition is moved 206 from a child position with respect to the “Display” digital media channel to being at the same hierarchical level as the “Display” digital media channel by creating the “NineMSN” interface portion and dropping that portion onto an interface portion at a desired hierarchical position. In this case, the user can be seen in FIG. 7 to have moved the “NineMSN” partition from the “Display” partition to its own partition under the “Paid media” data partition.

Although the interface portions and windows displayed in FIGS. 6 and 7 relate to a hierarchical data partition structure, it is to be understood that other predetermined data structures could easily be envisaged by a skilled addressee. Moreover, it should be understood that in a particular dataset, one or more metric groupings (i.e. rows in the tables depicted in FIG. 5) may be assigned to multiple partitions (that is, overlapping partitions) or one or more metric groupings may be assigned to a single partition only (that is, non-overlapping portions).

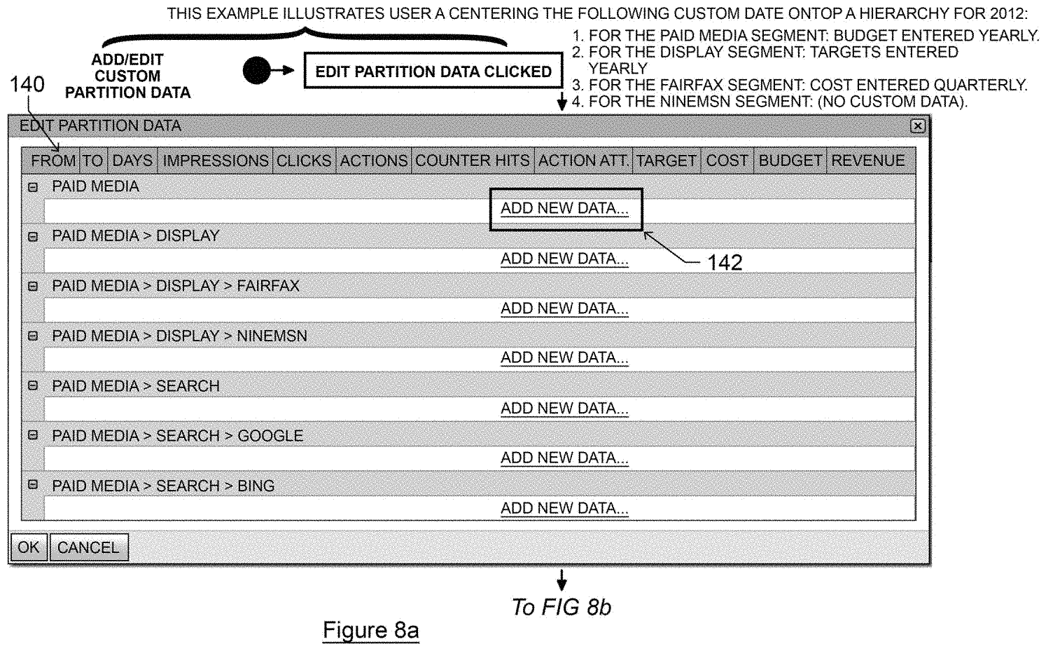

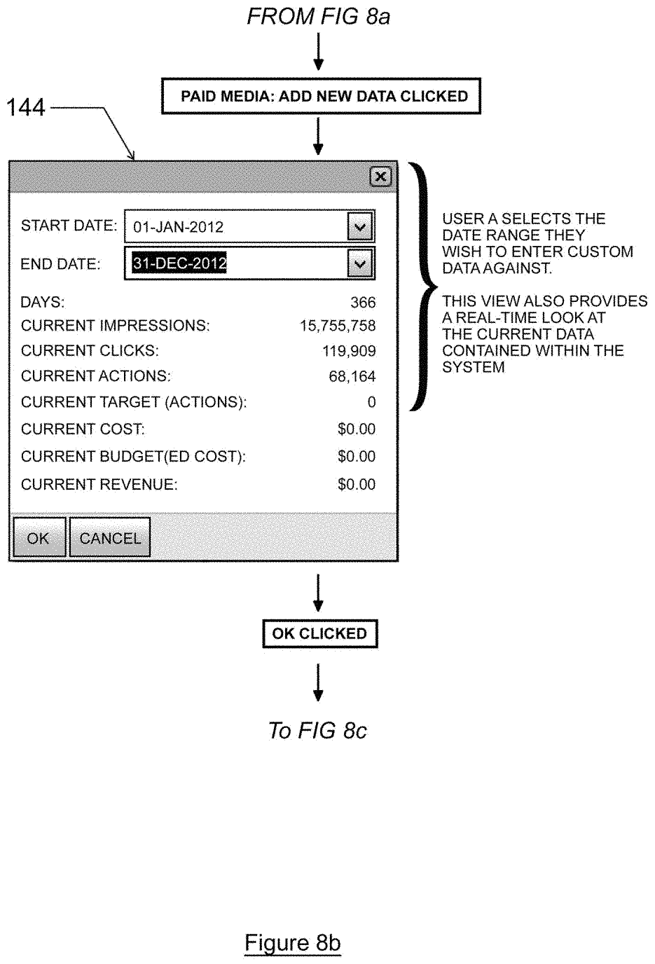

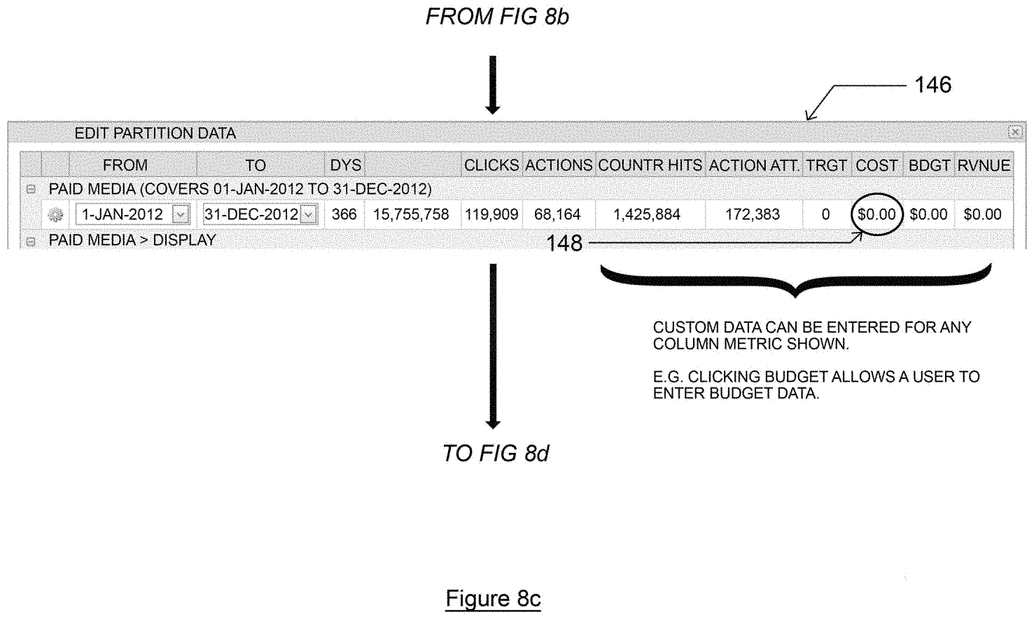

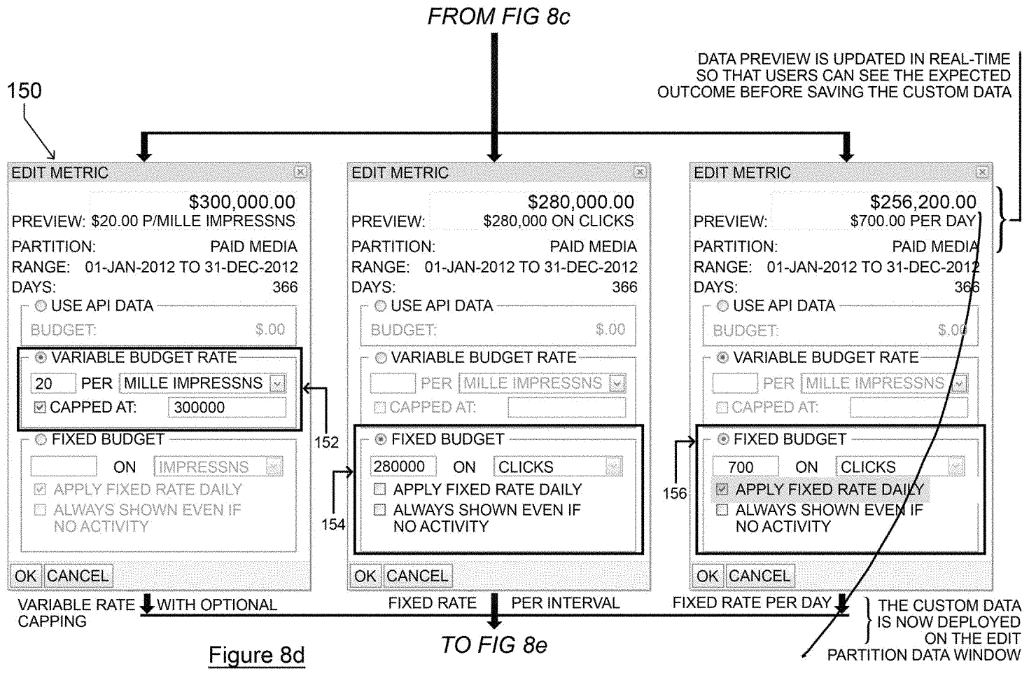

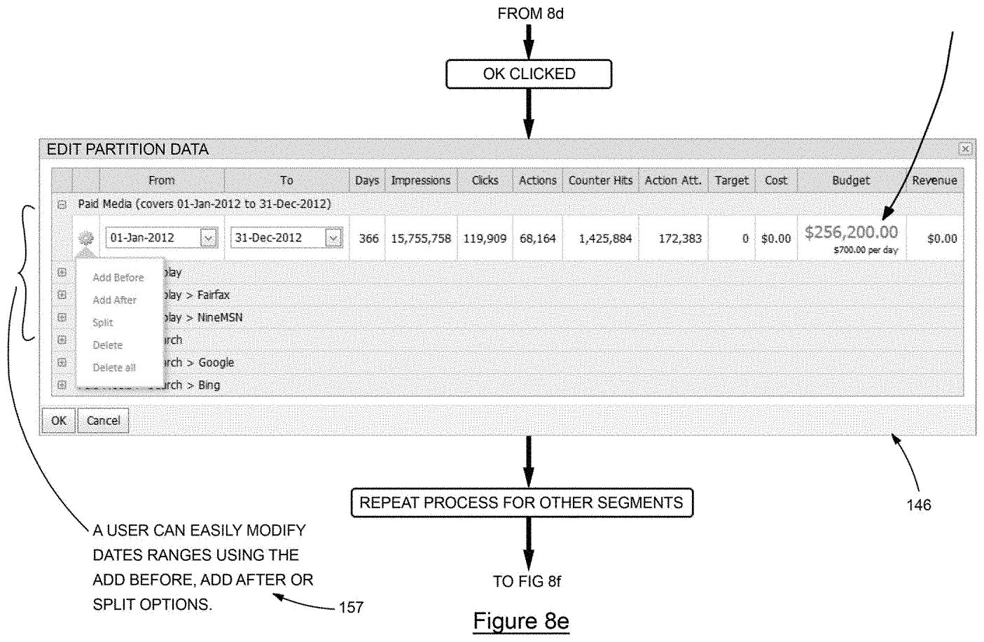

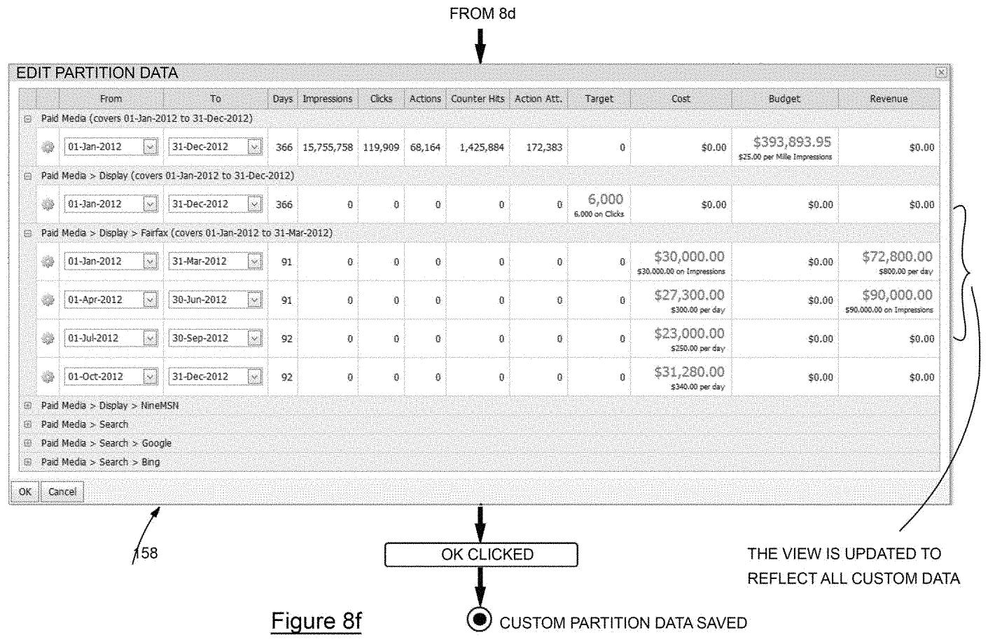

The graphic user interface 30 also enables a user 160 to provide supplementary metrics and/or dimensions to a dataset 170. As seen in FIGS. 8a to 8c and FIG. 9, when a user clicks or otherwise selects the interface portion corresponding to the data partition 125 they wish to edit, an editing interface window 140 is presented. In the example depicted in these figures, a user enters custom data 172 into a data hierarchy for the year 2012:
1. for the “paid media” segment, budget is entered yearly using the variable rate with optional capping functionality 174 and 152,
2. for the “display” segment, targets are entered yearly using the fixed rate per interval functionality 154 and 176,
3. for the “Fairfax” segment, Costs & Revenue are entered quarterly using the fixed rate per day 156 and 178 and the fixed rate per interval functionality,
4. for the “NineMSN” segment, no custom data is entered.

As shown in FIGS. 8a and 9, when the user clicks “add new data” displayed in the zone 142 of the interface window 140 corresponding to the “paid media” partition, the user is presented at the graphic user interface 30 with an interface window 144 enabling the user to enter a date range they wish to enter custom data against 184. The interface window 144 also provides a real time look at the current data contained within the system.

Once that date range has been entered, a further interface window 146, as shown in FIG. 8b, is presented to the user in order that custom metrics can be entered for that date range. In the depicted example, budget data 148 is entered by the user in the “budget” column.

Once a particular metric is selected for editing, a further interface window 150 is presented to the user to enable editing of that metric. In the depicted example, “variable budget rate” data is able to be entered in a window portion 152 and “fixed budget” data is able to be entered in a window portion 154.

In instances where a first metric is derived from a second metric by multiplying the second metric by a fixed coefficient (e.g. fixed cost per click), a user uses the panel 152 depicted in FIG. 8b, with the option of preventing the second metric from exceeding a limit. This limit is useful for example in the common use case when an advertising insertion order contains a rate to pay-per-click as well as a maximum spend for that month.

In instances where the absolute value of a metric is known outright (for example, total spend is known in absolute terms after activity has finished running), then one uses the panel 154 depicted in FIG. 8b. If however only an estimate is known, then it is useful to specify this on a daily basis (for example, forward looking budgets) and thus one would tick the ‘Apply fixed rate daily’ box 156 depicted in FIG. 8b. Furthermore, in either case data may not be present in the data warehouse 12 as yet for the given interval, and thus a metric grouping may need to be added to the dataset to contain the desired metric (for example, with forward looking budgets there will be no data for months that have not occurred as yet). In this instance, one would tick the ‘Always shown even if no activity’ option in boxes 154 and 156 to cause the creation of the necessary metric groupings required to deliver the desired outcome.

Once the selected metric has been edited, the graphic user interface 30 once again presents the interface window 146 to the user, as shown in FIGS. 8c and 9, to enable modification of the date range entered in interface window 144 and 180.

The aforementioned process is able to be repeated at the graphic user interface 30 for all other data segments for which supplementary metrics are desired to be added or existing metrics changed. The augmented dataset or supplementary metrics can be displayed in an interface window 158 viewed by the user prior to confirmation and updating of the dataset.

FIG. 9 depicts a user case diagram summarising the various system behaviours able to be performed by a campaign manager 160 of the graphic user interface 30 as well as system behaviours able to be performed by an ETL caretaker 162 and an ETL pipeline 164.

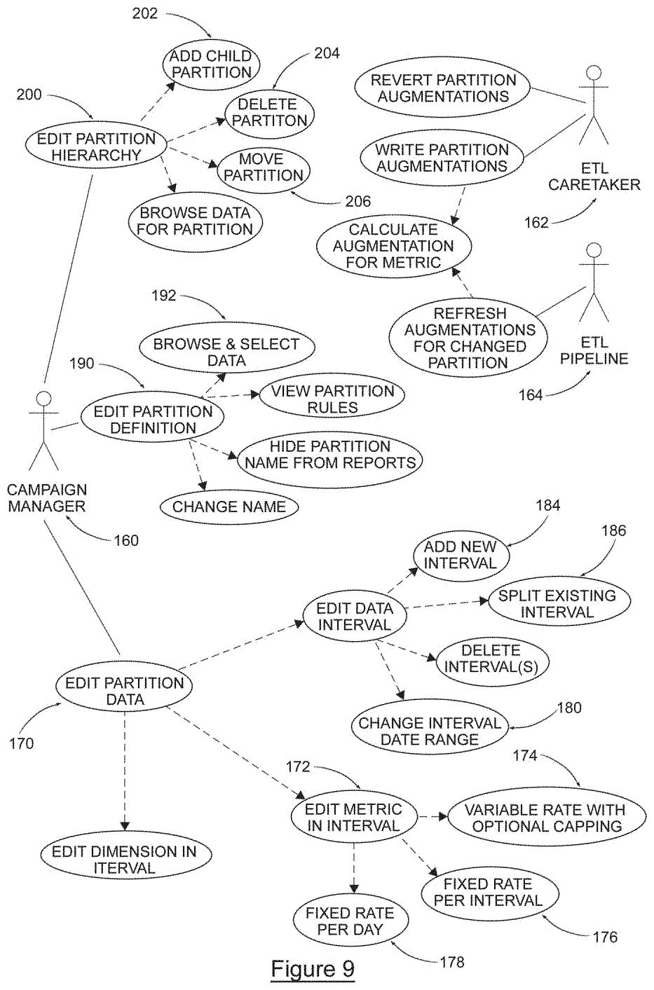

The resultant database structure using the stored dimensions, metrics, as well as the stored partition identifiers (hierarchical information) and associated augmented metrics is shown in FIG. 10.

The partition table 220 contains the hierarchy of partition IDs in which a parent partition ID 222 is used to create a tree structure. Connected to this table are the filtergroups 224 and 226 which defined which dimensions are covered by a partition, and the datarows 228 and 230 which contain supplemental dimension 221 and metric 229 augmentations for a particular interval.

A data partition can contain multiple views of the same dataset (for example, data from a search platform and data from a third party advertisement server, data from an email platform and from a website analytics package). In this instance, metrics such as cost might be present in one dataset, conversions in the other and clicks may be counted twice. To deal with this, the datasets from various sources can be merged by the database server 24 to a single view in which groupings (rows) are combined and duplication is removed by application of a mapping function.

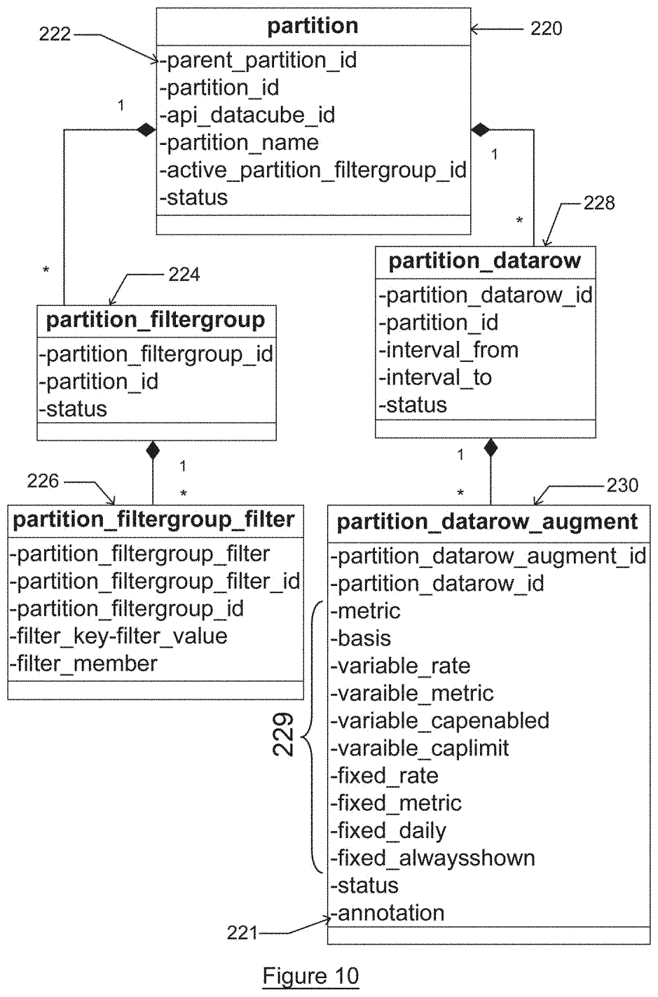

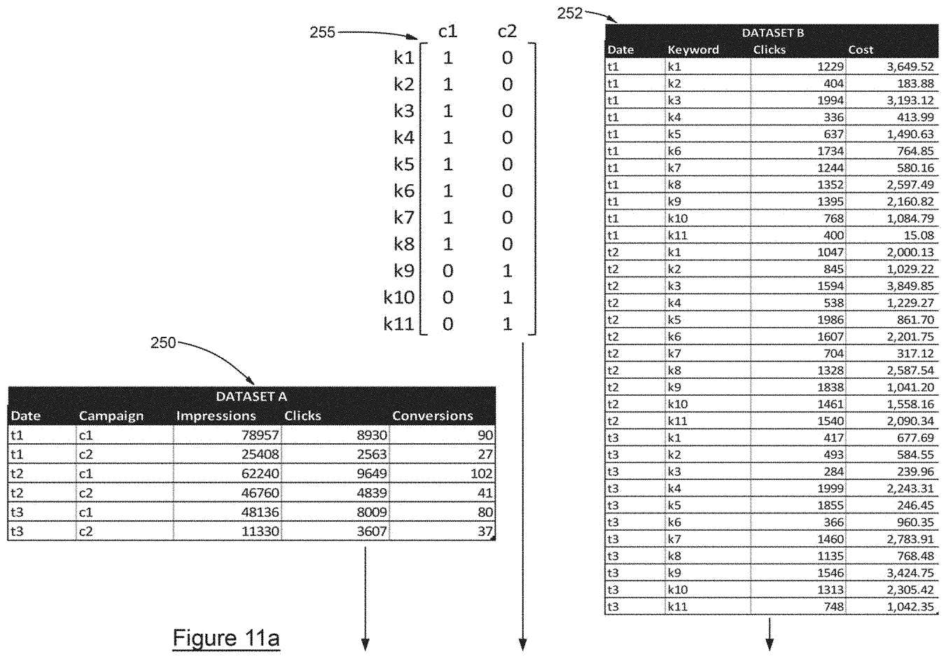

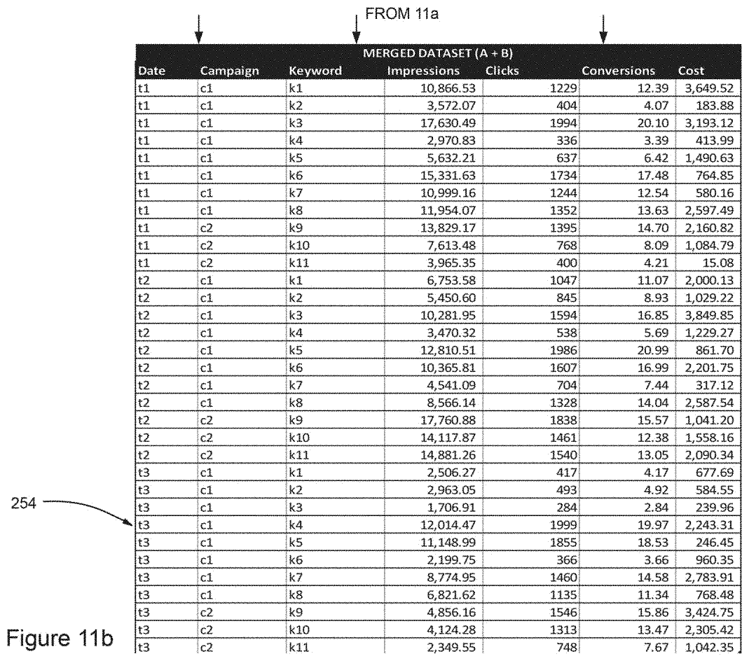

By way of explanation, FIG. 11 depicts a first dataset 250 including dimensions of date and campaign, and including the metrics of impressions, clicks and conversions. A further dataset 252 includes the dimensions of data and keywords and the metrics of clicks and cost. A merged dataset 254 is generated by the database server 24 by application of a mapping function 255 once datasets from different sources are received by the database server 24, each dataset comprising metric groupings each defining a different combination of dimensions, the multiple datasets are merged into a single dataset by application of the mapping function 256 to the first and second datasets 250 and 252. The mapping function acts to determine which levels of a dimension in the first dataset 250 are mapped on to which levels of another dimension in the second dataset 252.

Preferably, the mapping function is one which is learned from the first and second datasets. To learn the map function the database server 24 requires two datasets, a highly correlated (but possibly noisy) metric (M) that occurs in both datasets (e.g., Clicks & Visits), the name of a dimension in the first dataset (X) upon which should be mapped the levels of some other named dimension in the second dataset (Y) and several days (T) or other periods which co-occur in both datasets.

The map function (B) can then be recovered by solving the following linear equation:

B≅A\hat{ }(−1)C

subject to the following constraints on B:
B is a positive integer matrix
The sum of all cells in the matrix B are equal to MAX(|X|,|Y|)

### Where:

A is a matrix constructed from the second dataset consisting of |T| rows and |Y| columns. Each row in the matrix contains the value of M for one whole day, and each column contains the value of M for one level in the dimension Y,
C is a matrix constructed from the first dataset consisting of |T| rows and |X| columns. Each row in the matrix contains the value of M for one whole day, and each column contains the value of M for one level in the dimension X, and
B is the map function.

When implemented by the database server 24, the following observations can apply:
a linear or non-linear solver may be used to calculate B. The same general form applies.
a least-squares matrix solver can be used without the constraint, however a minimum of MAX(|X|,|Y|) days of data is required.
some linear algebra solvers will require the matrices to be made into square matrices. The behaviour of the algorithm is the same.
introducing the constraint reduces the number of days of data required.
if the metric M is noisy (that is, it's not a perfect mapping) then proportions should be used in its place.
an optimizer based solution which chooses the map matrix B that minimizes the squared error in M will produce the best result, but can be computationally expensive.

The following example uses the data from databases 252 and 254 depicted in FIG. 10, where the following map function is to be learned:

{c1}={k1, k2, k3, k4, k5, k6, k7, k8}

{c2}={k9, k10, k11}

then the following linear system is to be solved:

$$k 1 k 2 k 3 k 4 k 5 k 6 k 7 k 8 k 9 k 10 k 11$$

$${\begin{matrix}t 1 \\ t 2 \\ t 3\end{matrix} [ \begin{matrix}1229 & 404 & 1994 & 336 & 637 & 1734 & 1244 & 1352 & 1395 & 768 & 400 \\ 1047 & 845 & 1594 & 538 & 1986 & 1607 & 704 & 1328 & 1838 & 1461 & 1540 \\ 417 & 493 & 284 & 1999 & 1855 & 366 & 1460 & 1135 & 1546 & 1313 & 748\end{matrix} ]}_{{{⏟}_{A matrix}}_{( derived from first dataset )}} \times \\ c 1 c 2$$

$${\begin{matrix} k 1 \\ k 2 \\ k 3 \\ k 4 \\ k 5 \\ k 6 \\ k 7 \\ k 8 \\ k 9 \\ k 10 \\ k 11\end{matrix} [ \begin{matrix}1 & 0 \\ 1 & 0 \\ 1 & 0 \\ 1 & 0 \\ 1 & 0 \\ 1 & 0 \\ 1 & 0 \\ 1 & 0 \\ 0 & 1 \\ 0 & 1 \\ 0 & 1\end{matrix} ]}_{{{{⏟}_{B matrix}}_{( learned}}_{map function )}} = \\ c 1 c 2$$

$${\begin{matrix}t 1 \\ t 2 \\ t 3\end{matrix} [ \begin{matrix}8930 & 2563 \\ 9649 & 4839 \\ 8009 & 3607\end{matrix} ]}_{{{{⏟}_{C matrix}}_{( derived from}}_{second dataset )}}$$

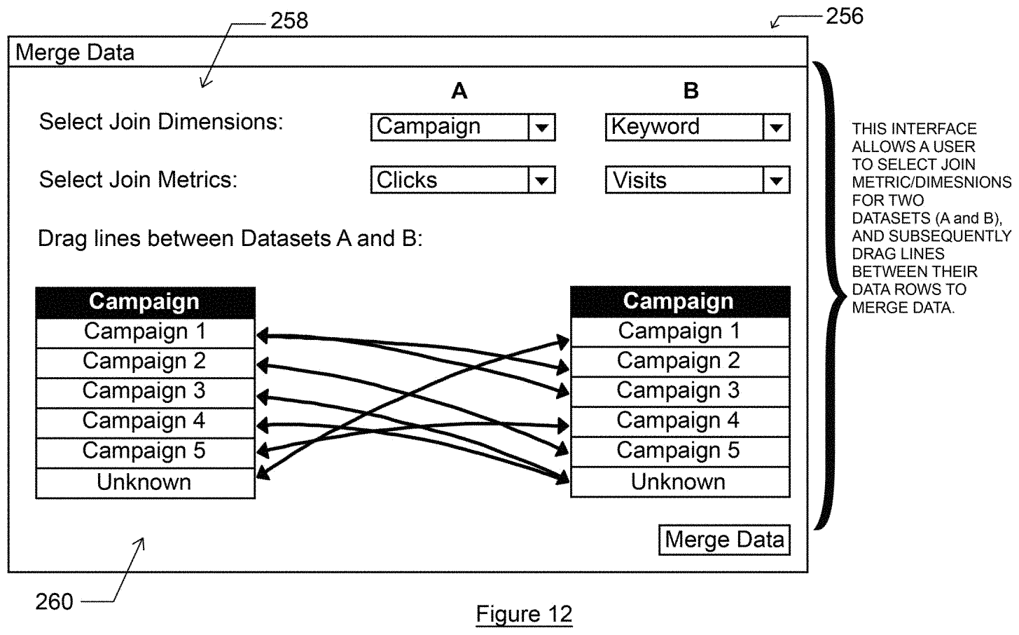

FIG. 12 depicts an interface window 256 displayed at the graphic user interface 30 which enables the user to select the metrics and/or dimensions from the two datasets which are to be joined by positioning opposing ends of at least one connector onto graphic elements representing metrics and/or dimensions to be joined. In an upper portion 258 of the interface window 256, the user is able to select, from drop-down lists, both dimensions and metrics from each of the two datasets to be joined. In a lower portion 260 of the interface window, the user is able to select associations between the dimensions selected in the upper portion 258, and by dragging interconnecting lines between a metric selected from a first dataset to a metric selected from a second dataset, is easily able to alter those associations.

From the foregoing it will be appreciated that the present invention enables users to reorganise their advertising datasets, and to augment their datasets with additional dimension and metric information, before, during and after advertising activity has run.

Datasets are able to be easily segmented using a hierarchical drag and drop interface that provides a user with ease of use and flexibility. Segment definitions and custom data are retained when moving segments so that a user can continue to easily manage and update their digital advertising data should their business needs evolve.

Custom data can be entered against a range of dimensions and metrics rather than a single metric only, such as cost. Additional metrics including business entry metrics such as targets, forecasts, budgets etc. can be entered which are often used by digital marketing teams to assess the performance of digital media purchasing.

The present invention also enables a real time preview of custom data to be provided before changes are saved. This view provides an assurance layer and helps to prevent errors that could decrease the accuracy of existing data within the system.

The invention also provides a mechanism for easily splitting custom data date ranges 186 and 157, making custom data entry easier and more intuitive than existing solutions.

Custom data appearing in a particular report is also able to be limited, if so desired.

As has been previously mentioned, although the present invention has been described in relation to its application to advertising datasets, the invention is also applicable to any dataset in general. Any company with a data warehouse that has a need to reorganise their datasets, is able to add additional data to their datasets and merge these multiple datasets together.

Although in the above described embodiments the invention is implemented primarily using computer software, in other embodiments the invention may be implemented primarily in hardware using, for example, hardware components such as an application specific integrated circuit (ASICs). Implementation of a hardware state machine so as to perform the functions described herein will be apparent to persons skilled in the relevant art. In other embodiments, the invention may be implemented using a combination of both hardware and software.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. A computer-implemented method of processing metrics via a controller, the controller comprising a processor and a memory storing code which when executed by the processor causes implementation of the steps of:
receiving a first dataset X characterising digital traffic and/or related user behaviour from a first source, the first dataset X including data of a first metric;
a second dataset Y characterising digital traffic and/or related user behaviour from a second source, the second dataset Y including data of a second metric, wherein the second metric is correlated to the first metric;
based on the correlation between the second metric and the first metric, generating a mapping function configured to merge the first dataset X with the second dataset Y; and
merging the first dataset X with the second dataset Y into a third dataset by application of the mapping function to the first dataset X and second dataset Y, such that the third dataset includes the data of the first dataset X and the second dataset Y.

2. A computer-implemented method according to claim 1, wherein the code when executed by the processor further causes implementation of the step of:
learning the mapping function from the first dataset X and the second dataset Y.

3. A computer-implemented method according to claim 2, wherein
the mapping function B≅A⁻¹C,
A being a matrix constructed from the second dataset Y and consisting of |T| rows and |Y| columns, each row in A containing the value of a metric M that occurs in both the first and the second datasets for a predetermined period, and each column in A contains the value of M for one level in the dimension Y; and
C being a matrix constructed from the first dataset X consisting of |T| rows and |X| columns, each row in C containing the value of M for the predetermined period, and each column in C contains the value of M for one level in the dimension X.

4. A computer-implemented method according to claim 3, wherein
when B is a positive integer matrix, and the sum of all cells in the matrix B is equal to MAX(|X|,|Y|),
a linear or non-linear solver is run by the processor to learn the mapping function B.

5. A computer-implemented method according to claim 3, wherein a least-squares matrix solver is run by the processor to learn the mapping function B.

6. A controller for processing metrics, the controller comprising a processor and a memory storing code which when executed by the processor causes implementation of the steps of:
receiving a first dataset X characterising digital traffic and/or related user behaviour from a first source, the first dataset X including data of a first metric;
receiving a second dataset Y characterising digital traffic and/or related user behaviour from a second source, the second dataset Y including data of a second metric, wherein the second metric is correlated to the first metric;
based on the correlation between the second metric and the first metric, generating a mapping function configured to merge the first dataset X with the second dataset Y; and
merging the first dataset X with the second dataset Y into a third dataset by application of the mapping function to the first dataset X and second dataset Y, such that the third dataset includes the data of the first dataset X and the second dataset Y.

7. The controller for processing metrics according to claim 6, wherein the code when executed by the processor further causes implementation of the step of
selecting metrics and/or dimensions from the first and second datasets which are to be joined by positioning opposing ends of at least one connector onto graphic elements representing metrics and/or dimensions to be joined.

8. The controller for processing metrics according to claim 6, the steps further comprising learning the mapping function from the first dataset X and the second dataset Y.

9. The controller for processing metrics according to claim 8, wherein:
the mapping function is represented by B≅A⁻¹C, wherein
A being a matrix constructed from the second dataset Y and consisting of |T| rows and |Y| columns, each row in A containing the value of a metric M that occurs in both the first and the second datasets for a predetermined period, and each column in A contains the value of M for one level in the dimension Y, and
C being a matrix constructed from the first dataset X consisting of |T| rows and |X| columns, each row in C containing the value of M for the predetermined period, and each column in C contains the value of M for one level in the dimension X.

10. The controller for processing metrics according to claim 9, wherein:
when B is a positive integer matrix, and the sum of all cells in the matrix B is equal to MAX(|X|,|Y|),
a linear or non-linear process is used to learn the mapping function B.

11. The controller for processing metrics according to claim 9, wherein the linear or non-linear process used to learn the mapping function B is a least-squares matrix process.
